(19) United States
(12) Patent Application Publication
(10) Pub. No.: US 2002/0145331 A1
(43) Pub. Date: Oct. 10, 2002

(54) Bicycle wheel hub with strengthening mechanism

(76) Inventors: Chin-Fu Wu, Nan-Tou (TW); Chin-Chang Wu, Taiping (TW)

Correspondence Address: Kuo-Hsiung Chiu, 13F, No.23, Jiun-Ho Street, Peitun District, Taichung, 406, TW

(21) Appl. No.: 09/828,426

(22) Filed: Apr. 9, 2001

(51) Int. Cl. B60B 27/00

(52) U.S. Cl. 301/110.5

(57) ABSTRACT

The present invention relates to a bicycle wheel hub with strengthening mechanism which includes a regulating spindle connected at the front and rear forks of the shaft of the wheel hub. Based on the opening or closed end of he fork, the shaft is adjusted from the original position to the appropriate position. Accordingly, the engagement among the chainwheel, the freewheel and the drive chain is slightly adjusted to a better condition. Besides, both ends of the shaft or one end thereof near the freewheel is able to be larger than the diameter of portion receiving the bearing by means of the adjustment of the screw joint so that the supporting strength is much improved.

### BACKGROUND OF THE INVENTION

1. Field of the Invention

The present invention relates to a bicycle wheel hub with strengthening mechanism, and more particularly, to a wheel hub which adjusts the engagement among the chainwheel, the freewheel and the drive chain to a better state while the supporting strength of the joint between the frame and the shaft can be improved.

2. Description of the Prior Art

In the whole frame of the bicycle, the power is transmitted to the freewheel by means that the chainwheel is engaged with the chain. Thus, the bicycle moves forward.

Conventionally, the front and rear forks of the bicycle frame are connected to the shafts of the bicycle wheel hubs. Moreover, the bicycle wheel hub utilizes the spokes and tire to join together as one body. Therefore, the shaft of the bicycle wheel hub will leave the prearranged central position degree by degree because the bicycle jolts over the rough roads, the bike-rider intentionally makes the wheel spring ups and downs. Accordingly, an unnecessary wearing during the power transmission is produced so that the bike-riding will be more and more strenuous. For the serious case, the engagement of the wheel teeth and the drive chain will easily fail, thereby causing the malfunction of the bike.

In addition, the shaft is the joint of the bicycle wheel hub and the front and rears forks. Also, it is the force-exerting and resisting point. Under restriction of the standard specification of the freewheel, bearing, etc., the diameter of two ends doesn't exceed the diameter of the mounting portion of the bearing. Although it won't be broken down because of the springing (or jumping) ride, the supporting force is still insufficient, especially, when the bike-riders stand on the add-on rods at two ends thereof. Accordingly, the smoothness during the riding is seriously influenced.

### SUMMARY OF THE INVENTION

It is a primary object of the present invention to remove the above-mentioned drawbacks and to provide a bicycle wheel hub which can adjust the engagement among the chainwheel, the freewheel and the drive chain to a better state, thereby reducing the possibility of the disengagement of the chain.

It is another object of the present invention to provide a bicycle wheel hub which improves the supporting strength of the joint between the frame and the shaft.

### BRIEF DESCRIPTION OF THE DRAWINGS

The accomplishment of this and other objects of the invention will become apparent from the following description and its accompanying drawings of which:

FIG. 1 is a perspective view of the shaft of the present invention;

FIG. 2 is a perspective view of another shaft of the present invention;

FIG. 3 is a sectional assembly view of the wheel hub and the shaft while the rear fork is marked by dotted line;

FIG. 4 is a sectional view of the joint portion with a treading rod;

FIG. 5 is a sectional view of the joint among the regulating mechanism, the shaft and the fork; and

FIG. 6 is a sectional view of the joint among another regulating mechanism, the shaft and the fork.

### DETAILED DESCRIPTION OF THE PREFERRED EMBODIMENT

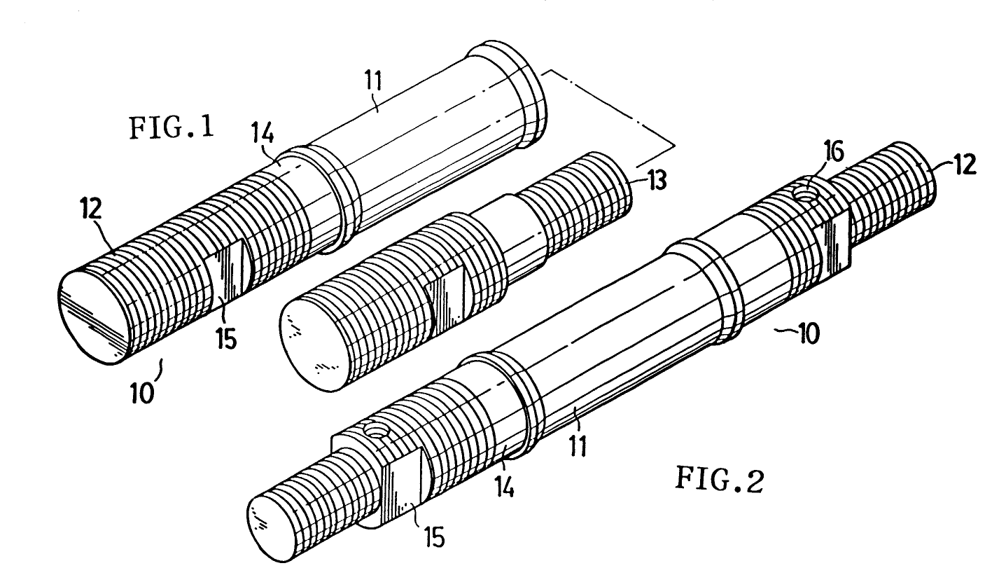

Referring to FIG. 1, a strengthened shaft 10 is divided into an embedded portion 11 and two threaded joint portions 12. The threaded joint portions 12 each include two locating portions 15 being recess-shaped and disposed parallel to each other. A smooth mounting portion 14 is formed between the threaded portion and the embedded portion 11. The free end of the mounting portion 14 of a threaded joint portion 12 is provided with a threaded portion 13 in the axial direction.

An adjustable shaft 10, as shown in FIG. 2, is also divided into an embedded portion 11 and two threaded joint portions 12. Besides, the threaded joint portions 12 each have two locating portions 15 being recess-shaped and disposed parallel to each other and a smooth mounting portion 14. The adjustable shaft 10 differs from the strengthened shaft 10 in that the former is formed in a body and is provided with a regulating hole 16 passing through the threaded portion between both locating portions 15.

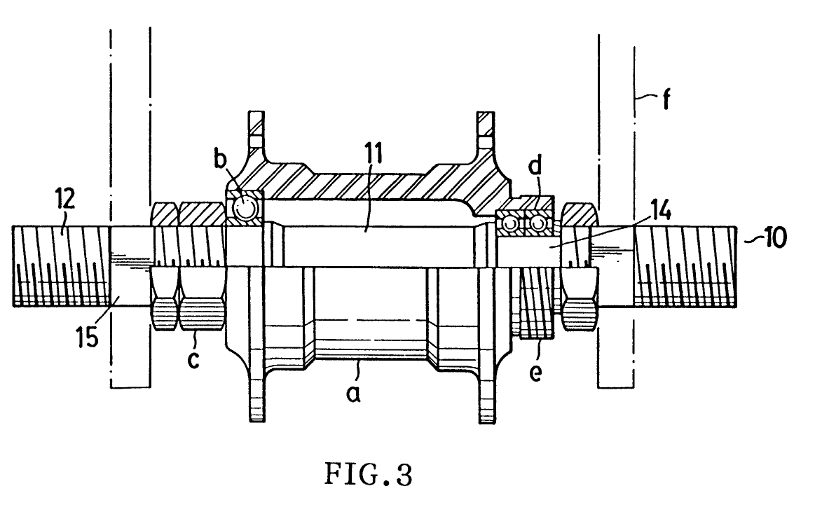

A combination shaft 10 of the above two is shown in FIG. 3. It's apparent from FIG. 3 that the portion of the threaded joint portion 12, whose diameter greater than the mounting portion 14, is inserted from one end of the wheel hub (a) with the freewheel-fixing portion (e) so that the mounting portion 14 is attached to the bearing (b) in the bearing groove (d). Another portion is inserted from the opposing end of the wheel hub (a) in order for the embedded portion 11 to connect with the threaded portion (not shown) in a body. Thereafter, a screw (c) together with a washer is driven from both ends thereof into the bearing (b) for completing the assembly procedure.

The center of both ends of the shaft 10 is situated at a phantom line and won't be deviated by means of the design of the bearing groove (d) of the wheel hub (a) and the assembly of the standard bearing (b) and the mounting portion 14. The washer and the screw (c) will enable both locating portions 15 to adjust to a horizontal phantom line for connecting with the rear fork (f) (shown with dotted line).

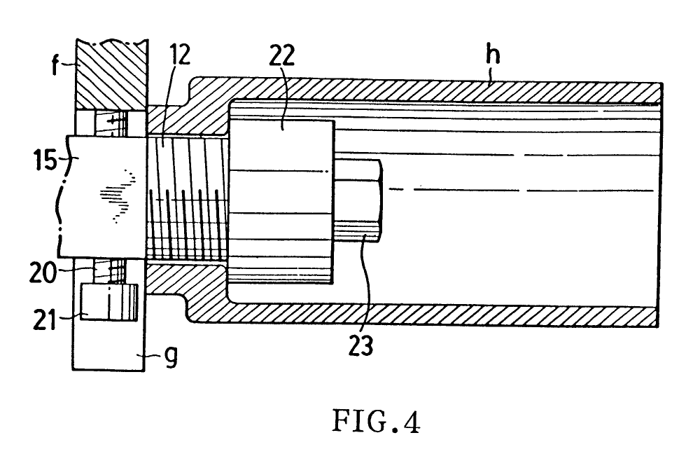

The corresponding relationship of the joint between the fork and the shaft 10 can be shown in FIGS. 4 and 6. The thickness between both locating portions 15 of the threaded joint portion 12 is the same to or slightly smaller than the length of an opening (g) of the rear fork (f) so that the former can be inserted into the opening. A regulating spindle 20 includes a drive end 21 in shape of polygonal groove while the other end thereof is screwed with the regulating hole 16 and supports against the closed end of the opening (g) of the rear fork (f).

When the user utilizes a tool to drive the drive end 21 to turn the regulating spindle 20, a pulling force in the direction of the chainwheel to the wheel hub (a) together with the shaft is created because of the engagement of the chainwheel, the freewheel (not shown) and the chain. However, it won't be moved as the regulating spindle 20 supports against the closed end of the opening (g) of the rear fork (f).

If the drive end 21 is turned to couple with the regulating hole 16 to screw in the left direction for displacement, the locating portions 15 will enable the threaded joint portion 12 to move in the same direction on the top and bottom edges of the opening (g). At this time, the clearance between the shaft of the wheel hub (a) and the shaft center of the chainwheel will be enlarged. In the contrary, if the regulating spindle 20 is turned to move the threaded joint portion 12 forward in the right direction of the figure, the clearance between the shaft of the wheel hub (a) and the shaft center of the chainwheel will be shortened.

When the threaded joint portion 12 is moved forward on the stationary regulating spindle 20, the increased distance of the wheel hub on the rear fork (f) is slight. However, it has the following advantages:

1. The height value of the teeth of the chainwheel or the freewheel is not large. Thus, the forward and rearward movement distance on the regulating spindle 20 is enough to adjust the engagement of the teeth and the chain holes to a better state, thereby reducing the possibility of disengagement.

2. The power is transmitted from the chainwheel to the freewheel by means of the chain. If the engaging condition can be adjusted by the bike-rider himself after using the bike, the power transmission will be smoother. Also, the service life will be prolonged.

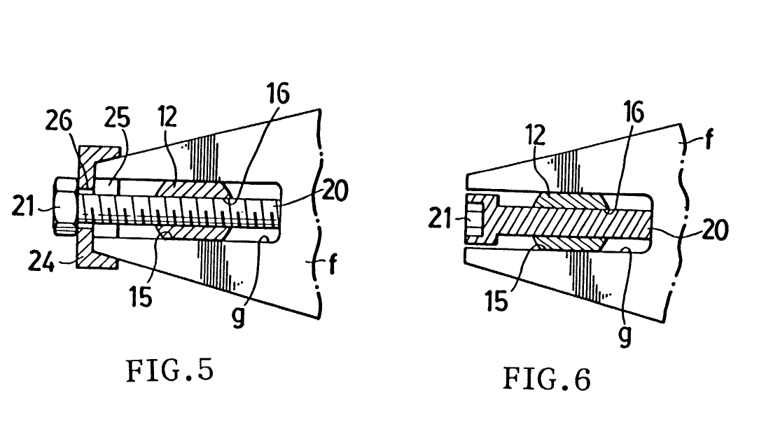

Another corresponding relationship of the joint between the fork and the shaft 10 is shown in FIG. 5. Similarly, the opening of the rear fork (f) of both locating portions 15 of the threaded joint portion 12 slides into the opening (g). A regulating spindle 20 includes a polygonal drive end 21 at one end thereof while the other end thereof passes through the hole 26 in the middle of the locating block 24 and is screwed with the regulating hole 16. The locating block 24 includes a groove 25 on the surface of the hole 26 so that it can be mounted on the opening (g) of the rear fork (f). The drive end 21 supports against the outer rim of the locating block 24 by means of the pulling force among the chainwheel, the freewheel and the chain.

Based on the above-mentioned structure, it's no more important if the other end of the regulating spindle 20 supports against the closed end of the opening (g) of the rear fork (f) because the polygonal drive end 21 supports against the outer rim of the locating block 24. Besides, the operation steps and advantages thereof are identical so that no further descriptions are given hereinafter.

In addition, it's apparent from FIGS. 3 and 4 when the bike-rider want to add a treading rod (h) to the exposed portion of the threaded joint portion 12 with enlarged diameter on the shaft 10, one end of the neighbored rear fork (f) can be mounted or screwed on the threaded joint portion 12. Also, the both are screwed together by means of the locking element 22 of the polygonal drive head 23.

The advantages of the wheel hub (a) in comparison with the conventional lie in:

1. Supposed that the diameter of the threaded joint portion 12 is enlarged from 14 mm to 20 mm, the clearance of the diagonal line or the opposing sides is somehow enlarged when the conventional standard nut is used to lock the treading rod (h) and the shaft 10. The inner diameter of the treading rod (h) must also be enlarged to receive the socket or wrench for locking. However, the aforementioned drive head 23 of the locking element 22 can be designed as standard specification so that the locking procedure won't be influence if the maximal outer diameter at the other end is identical to the inner diameter of the treading rod (h).

2. The enlarged diameter of the threaded joint portions 12 at both ends of the shaft 10 can strengthen the structure of the fork. Also, more body weight on the treading rod (h) can be supported. This can't be reached by the conventional wheel hub (a) whose diameter at both end must be smaller than the shaft of the mounting portion.

Many changes and modifications in the above-described embodiments of the invention can, of course, be carried out without departing from the scope thereof. Accordingly, to promote the progress in science and the useful arts, the invention is disclosed and is intended to be limited only by the scope of the appended claims.

What is claimed is:

1. A bicycle wheel hub with strengthening mechanism comprising:
a wheel hub having a bearing at either end thereof; and
a shaft having a mounting portion in the middle thereof for receiving said bearing, a joint portion at either end thereof and locating portions for connecting with the opening of the fork;
wherein said shaft includes regulating holes disposed at the position of said locating portions, and one end thereof is provided with a regulating spindle of a drive end while a screw joint with said shaft by means of said regulating holes is created, and the other end thereof supports against the closed end of said opening of said fork, thereby adjusting the clearance between the freewheel and the chainwheel on said wheel hub; furthermore, the engagement between the drive chain and both wheels can be adjusted to a better condition.

2. A bicycle wheel hub with strengthening mechanism as claimed in claim 1 furthermore comprising a locating block having a groove at one side thereof and mounted on of said opening of said fork while said groove includes holes for receiving said regulating spindle in screw joint with said shaft so that said drive end supports against at outer side of said locating block.

3. A bicycle wheel hub with strengthening mechanism comprising:
a wheel hub having a bearing at either end thereof; and
a shaft having an embedded portion in the middle thereof, a joint portion at either end thereof and locating portions for connecting with the opening of the fork, each of said locating portions having a mounting portion for receiving said bearing, each of both joint portions near said embedded portion having a mounting portion for receiving said bearing;
wherein at least one end of said joint portion is constructed as an individual body, and whose diameter is larger than said mounting portion, and which includes a threaded portion in the axial direction for screwing said embedded portion to create a shaft so that the frame structure is strengthened and the supporting force is improved.

4. A bicycle wheel hub with strengthening mechanism as claimed in claim 3 furthermore comprising a locking element fastened on said joint portion, one end thereof being formed as a drive head to facilitate the screwing procedure.
